(19) United States
(12) Patent Application Publication
(10) Pub. No.: US 2012/0232444 A1
(43) Pub. Date: Sep. 13, 2012

(54) Abdominal massage device

(76) Inventor: Tsung-Sheng Chen, Taichung (TW)

(21) Appl. No.: 13/067,235

(22) Filed: May 18, 2011

(30) Foreign Application Priority Data
Mar. 9, 2011 (TW) 100204218

(51) Int. Cl. A61H 23/00

(52) U.S. Cl. 601/107

(57) ABSTRACT

An abdominal massage device includes a handle and a threaded tube is connected to the handle. The threaded tube includes an outer tube connected to the handle and an inner tube is located in the outer tube. An annular space is defined between the inner and outer tubes and a threaded rod is threadedly connected to the inner tube. A case includes a tubular portion and a board which is connected to the tubular portion. The tubular portion is mounted to the threaded rod and located within the space. A resilient member is located in the space and biased between the connector and the tubular portion. A massage disk is connected to the case and is cooperated with an eccentric member. The threaded rod drives the massage disk to spin by the movement of the eccentric member.

### FIELD OF THE INVENTION

The present invention relates to a massage device, and more particularly, to an abdominal massage device with vibrating feature.

### BACKGROUND OF THE INVENTION

A conventional abdominal massage device taps the user's abdominal muscles repeatedly so as to stimulate the muscles and burn the fat at the abdomen of the user.

However, the conventional abdominal massage device can only stimulate limited area and cannot massage a larger area of the abdomen of the user's body.

The present invention intends to provide an abdominal massage device which improves the inherent shortcomings of the conventional abdominal massage device.

### SUMMARY OF THE INVENTION

The present invention relates to an abdominal massage device and comprises a handle, a threaded tube, a threaded rod, an end tube, a case, a resilient member, an eccentric member and a massage disk, wherein the handle has two grips and the threaded tube is connected to the handle and located between the two grips. The threaded tube includes an outer tube and an inner tube, wherein the outer tube is connected to the handle and the inner tube is located in the outer tube. A connector is connected to two respective first ends of the inner and outer tubes so as to define an annular space between the inner and outer tubes. The space is sealed by the connector. The threaded rod is inserted into the inner tube and threadedly connected to the inner tube.

The end tube is connected to the first end of the threaded tube and pivotably connected to the handle. The threaded rod extends through the connector and is inserted into and pivotably connected to the end tube.

The case includes a tubular portion and a board which is connected to the tubular portion. The distal end of the tubular portion is mounted to the second end the threaded rod and located within the space.

The resilient member is located in the space and biased between the connector and the distal end of the tubular portion.

The massage disk is connected to the case and an eccentric member is located in the massage disk. The eccentric member has a base part and an eccentric rod. The second end of the threaded rod extends through the board and is connected to the base part. The eccentric rod is eccentric to the threaded rod so as to be pivotably connected to the axis of the massage disk. The threaded rod drives the massage disk to spin so as to massage the user's body by the movement of the eccentric member.

Preferably, a resilient band is hooked between a first hook on the handle and a second hook on the end tube. The resilient band provides a force to return the handle.

Preferably, the eccentric member includes a ring and the base part is a circular part. The ring is mounted to the outside of the base part and the ring has multiple rollers connected to the underside thereof. The massage disk has a recess defined in the underside thereof and the eccentric member is engaged with the recess.

Preferably, the handle has a first sleeve connected between the grips and the threaded tube is connected to the first sleeve so as to connect the threaded tube to the handle.

Preferably, the handle has a balancing member and a second sleeve, wherein the balancing member has two ends connected to the two grips and the second sleeve is connected to the mediate portion of the balancing member. The second sleeve is located in alignment with the first sleeve, and the threaded tube extends through the second sleeve.

Preferably, the end tube extends through the second sleeve and is inserted between the first sleeve and the second sleeve. The end tube is axially connected to the handle.

Preferably, the threaded rod has a pivot extending from the first end thereof and the pivot is pivotably connected to the end tube. A bearing is located between the pivot and the end tube so that the threaded rod is pivotable relative to the end tube.

Preferably, the threaded rod has a pivot extending from the second end thereof and the pivot extends through the board and is pivotably connected to the eccentric member. A bearing is located between the pivot and the board so that the threaded rod is pivotable relative to the case.

The present invention further provides another embodiment of the abdominal massage device and comprises a handle with two grips and a threaded tube is connected to the handle. The threaded tube is located between the two grips and the handle has a first hook on the top thereof.

The threaded tube includes an outer tube and an inner tube, wherein the outer tube connected to the handle and the inner tube is located in the outer tube. A connector is connected to two respective first ends of the inner and outer tubes so as to define an annular space between the inner and outer tubes. The space is sealed by the connector. A threaded rod is inserted into the inner tube and threadedly connected to the inner tube.

An end tube is connected to the first end of the threaded tube and pivotably connected to the handle. The threaded rod extends through the connector and is inserted into and pivotably connected to the end tube. The end tube has a second hook connected to the top thereof.

A case includes a tubular portion and a board which is connected to the tubular portion. The distal end of the tubular portion is mounted to the second end of the threaded rod and located within the space.

A resilient member is a resilient band and hooked between the first and second hooks.

A massage disk is connected to the case and an eccentric member is located in the massage disk. The second end of the threaded rod extends through the board and is connected to the base part. An eccentric rod of the eccentric member is eccentric to the threaded rod so as to be pivotably connected to the axis of the massage disk. The threaded rod drives the massage disk to spin by the movement of the eccentric member.

The primary object of the present invention is to provide an abdominal massage device with vibrating feature so as to be repeatedly massage the abdomen of the user and the massage disk is able to vibrate to provide different massage function.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the abdominal massage device of the present invention;

FIG. 2 is a top view to show the abdominal massage device of the present invention;

FIG. 3 is a right side cross sectional view of the abdominal massage device of the present invention;

FIG. 4 is an enlarged cross sectional view of the position where the threaded tube is located;

FIG. 5 is an enlarged cross sectional view of the position where the eccentric part is located;

FIG. 6 is a front view of the second embodiment of the abdominal massage device of the present invention;

FIG. 7 is a right side cross sectional view of the second embodiment of the abdominal massage device of the present invention;

FIG. 8 is a right side cross sectional view of the third embodiment of the abdominal massage device of the present invention, and

FIG. 9 is an enlarged cross sectional view if the position of the fourth embodiment, where the eccentric part is located.

### DETAILED DESCRIPTION OF THE PREFERRED EMBODIMENT

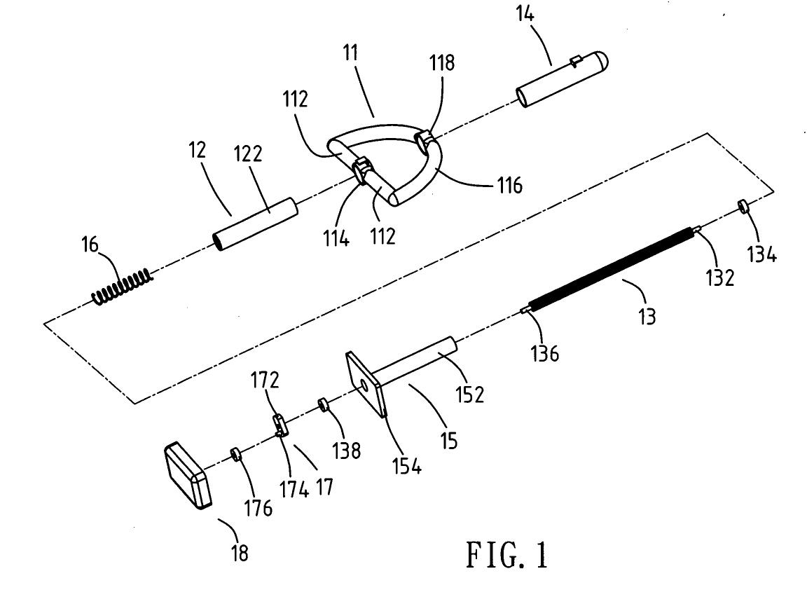

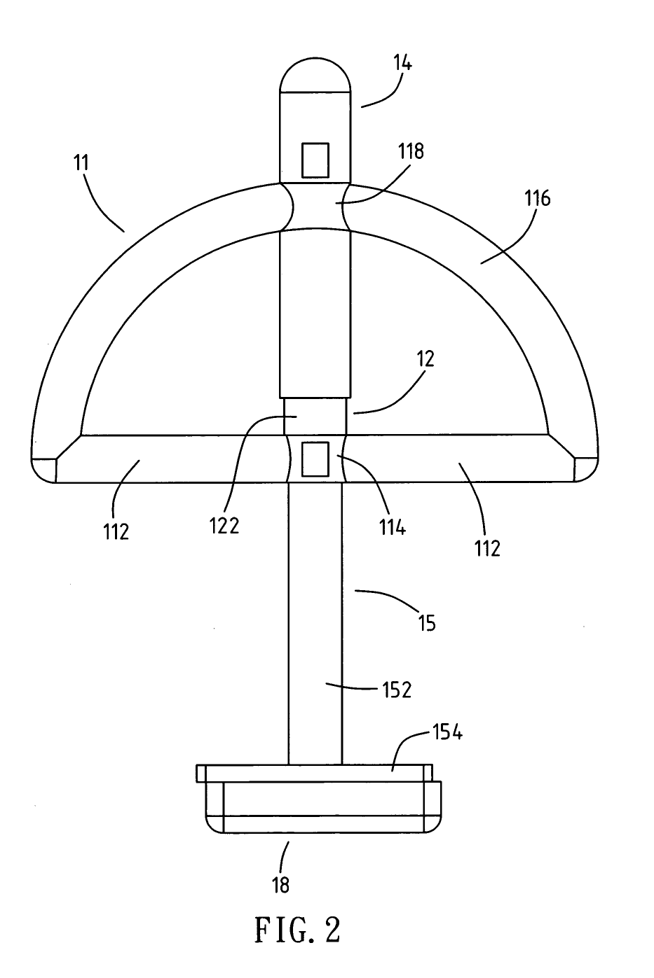

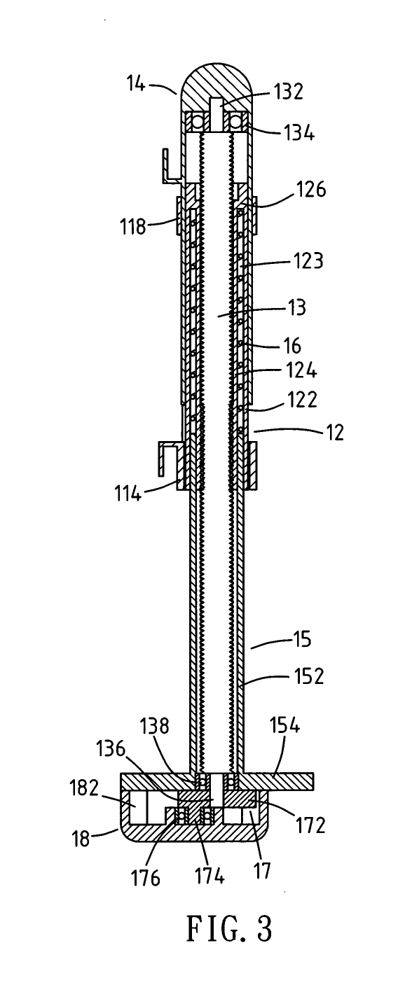

Referring to FIGS. 1 to 3, the abdominal massage device of the present invention comprises a handle 11, a threaded tube 12, a threaded rod 13, an end tube 14, a case 15, a resilient member 16, an eccentric part 17 and a massage disk 18. The handle 11 has two grips 112 and a threaded tube 12 is connected to the handle 11. The threaded tube 12 is located between the two grips 112. The handle 11 has a first sleeve 114 connected between the grips 112 and the threaded tube 12 is connected to the first sleeve 114 so as to connect the threaded tube 12 to the handle 11. The handle 11 has a balancing member 116 and a second sleeve 118. The balancing member 116 is a U-shaped member and has two ends connected to the two grips 112 and the second sleeve 118 is connected to the mediate portion of the balancing member 116. The second sleeve 118 is located in alignment with the first sleeve 114. The threaded tube 12 extends through the second sleeve 118.

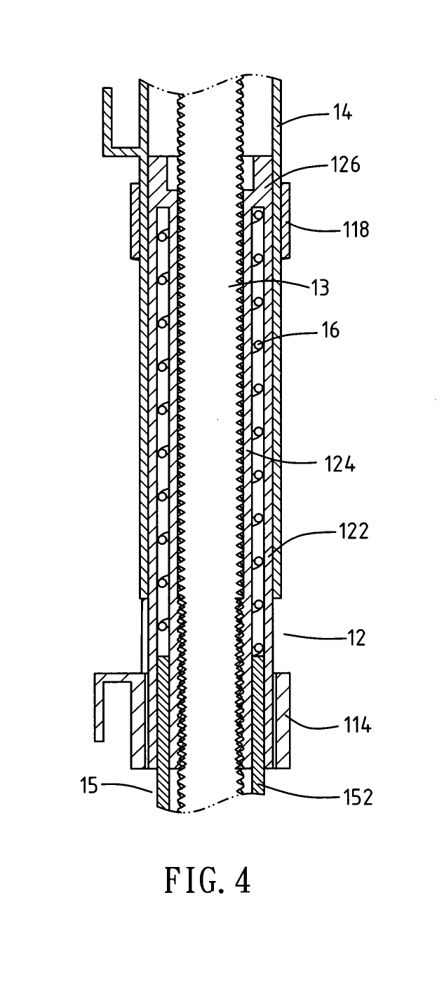

As shown in FIG. 4, the threaded tube 12 includes an outer tube 122 and an inner tube 124. The outer tube 122 connected to the first sleeve 114 of the handle 11 and the inner tube 124 is located in the outer tube 122. The outer tube 122 extends through the second sleeve 118 so that the threaded tube 12 is connected to the handle 11 and the threaded tube 12 is guided by the second sleeve 118. A connector 126 is connected to two respective first ends of the inner and outer tubes 124, 122 so as to define an annular space 123 between the inner and outer tubes 124, 122. The front end of the space 123 is sealed by the connector 126. A threaded rod 13 is inserted into the inner tube 124 and threadedly connected to the inner tube 124.

The end tube 14 has a closed front end and is connected to the first end of the threaded tube 12 and pivotably connected to the handle 11. The end tube 14 extends through the second sleeve 118 and is inserted between the first sleeve 114 and the second sleeve 118. The end tube 14 is axially connected to the handle 11. The threaded rod 13 extends through the connector 126 and is inserted into and pivotably connected to the end tube 14. The threaded rod 13 has a pivot 132 extending from the first end thereof and the pivot 132 is pivotably connected to the end tube 14. A bearing 134 is located between the pivot 132 and the end tube 14 so that the threaded rod 13 is pivotable relative to the end tube 14.

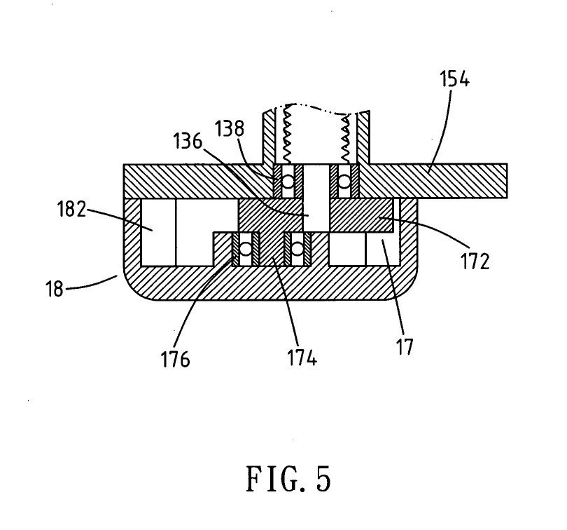

The case 15 includes a tubular portion 152 and a board 154 which is connected to the tubular portion 152. The distal end of the tubular portion 152 is mounted to the second end of the threaded rod 13 and located within the space 123. The resilient member 16 is located in the space 123 and biased between the connector 126 and the distal end of the tubular portion 152. As shown in FIG. 5, the threaded rod 13 has a pivot 136 extending from the second end thereof and the pivot 136 extends through the board 154 and is pivotably connected to the eccentric member 17. A bearing 138 is located between the pivot 136 and the board 154 so that the threaded rod 13 is pivotable relative to the case 15.

The massage disk 18 is connected to the case 15 and has a recess 182 defined in the underside thereof. The recess 182 faces the base part 172. The eccentric member 17 is located in the recess 182 of the massage disk 18. The eccentric member 17 has the base part 172 and an eccentric rod 174 extends from the base part 172. The second end of the threaded rod 13 extends through the board 154 and is connected to the base part 172. The eccentric rod 174 is eccentric to the threaded rod 13 so as to be pivotably connected to the axis of the massage disk 18. The threaded rod 13 drives the massage disk 18 to spin by the movement of the eccentric member 17. Therefore, the massage disk 18 can repeatedly massage the abdomen of the users.

When in use, the user holds the grips 112 by two ends and the massage disk 18 contacts the user's body, when the user pulls the handle 11 toward his/her body, the handle 11 moves the threaded tube 12 to move toward the user's body linearly so that the threaded tube 12 moves relative to the threaded rod 13. The threaded rod 13 spins because the engagement with the threaded tube 12. The rotation of the threaded rod 13 drives the eccentric member 17 and the massage disk 18 spins about the threaded rod 13 to massage the user. The massage disk 18 massages a larger area to the abdomen of the user and the user's body applies a reaction force to the massage disk 18 so that the abdominal muscles are also exercised. During the pulling action to the handle 11, the resilient member 16 is deformed by the threaded tube 12 and the case 15. The force of the resilient member 16 becomes the resistance to the handle 11 toward the abdomen of the user so that the muscles of the user's arm are exercised to pull the handle 11. When the user does not apply force to the handle 11, the resilient member 16 moves the threaded tube 12 together with the handle 11 to move away from the user. The reverse directional movement of the threaded tube 12 makes the threaded rod 13 to rotate reversely which drives the massage disk 18 to massage the user in opposite direction. When the massage disk 18 changes its direction, the massage disk 18 vibrates and the vibration is applied to the user's body.

By linearly and repeatedly movement of the handle 11, the massage disk 18 massages the user's body in a larger area and provides vibration. Not only the abdomen but also the muscles of arms are exercised.

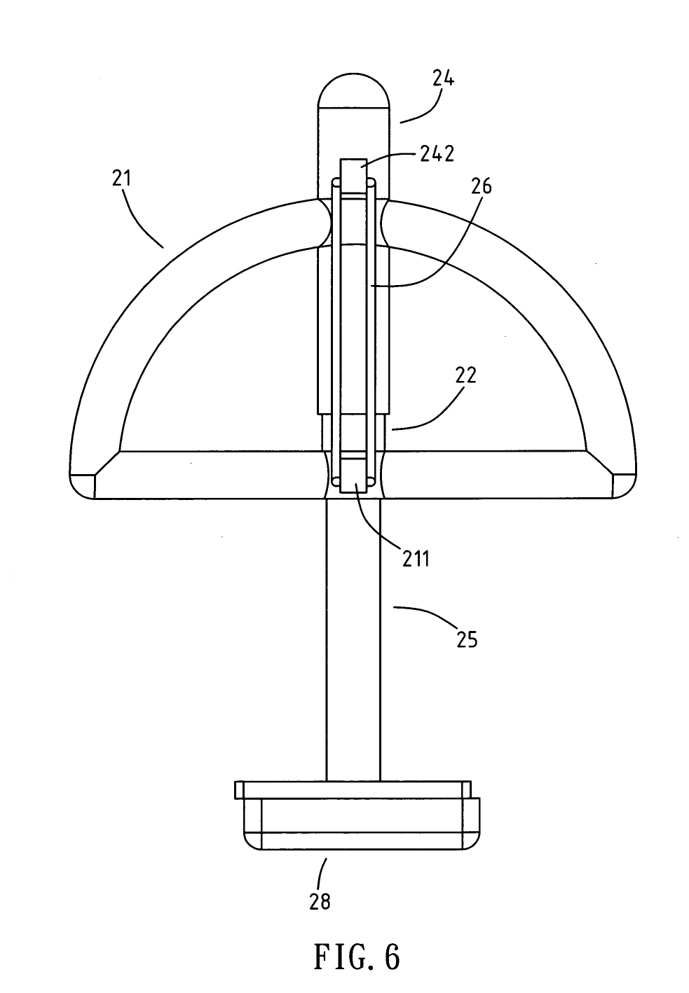

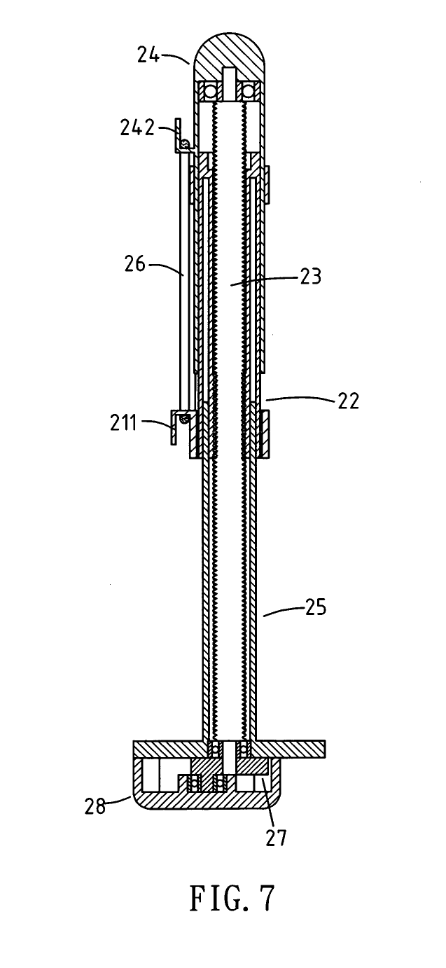

The second embodiment is similar to the first embodiment, as shown in FIGS. 6 and 7, and comprises a handle 21, a threaded tube 22, a threaded rod 23, a end tube 24, a case 25, at least one resilient member 26, an eccentric member 27 and a massage disk 28. The handle 21 has a first hook 211 on the top thereof and a second hook 242 is formed on the top of the end tube 24. The resilient member 26 is a resilient band which is hooked between the first and second hooks 211, 242 so as to provide force to return the handle 21. The number of the resilient member 26 can be increased according practical need. When multiple resilient members 26 are used, the user has to apply more force to operate the handle 21 of the massage device and the muscles are further exercised.

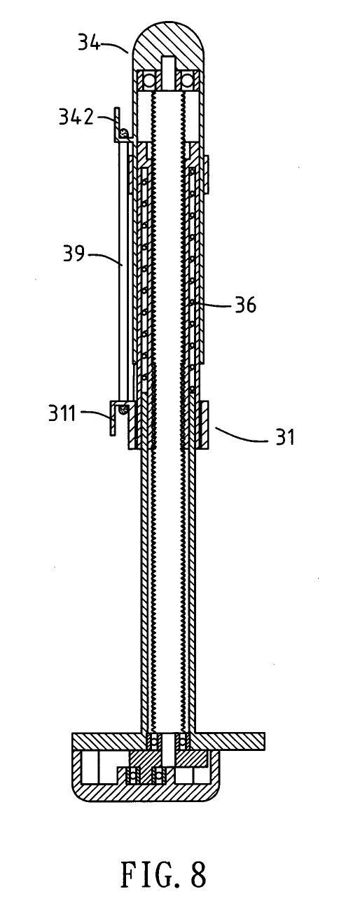

As shown in FIG. 8 which shows the third embodiment which is similar to the first and second embodiments and the differences are that the third embodiment includes a resilient band 39 which is hooked between the first hook 311 on the handle 31 and the second hook 342 on the end tube 34. When the handle 31 is moved, the resilient member 36 and the resilient band 39 provide a force to return the handle 31.

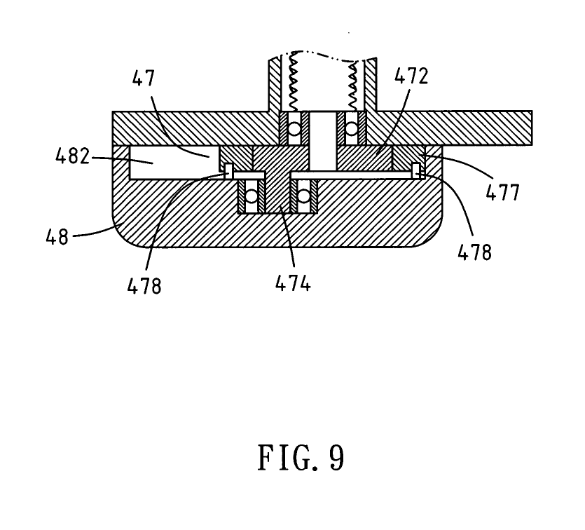

As shown in FIG. 9 which shows the fourth embodiment which is similar to the first embodiment and the eccentric member 47 includes a ring 477. The base part 472 is a circular part and the ring 477 is mounted to the outside of the base part 472. The ring 477 has multiple rollers 478 connected to the underside thereof. The massage disk 48 has a recess 482 defined in the underside thereof and the eccentric member 47 is engaged with the recess 482 so that the massage disk 48 operates smoothly.

While we have shown and described the embodiment in accordance with the present invention, it should be clear to those skilled in the art that further embodiments may be made without departing from the scope of the present invention.

What is claimed is:

1. An abdominal massage device comprising:
a handle having two grips and a threaded tube connected to the handle, the threaded tube located between the two grips;
the threaded tube including an outer tube and an inner tube, the outer tube connected to the handle and the inner tube located in the outer tube, a connector connected to two respective first ends of the inner and outer tubes so as to define an annular space between the inner and outer tubes, the space being sealed by the connector, a threaded rod inserted into the inner tube and threadedly connected to the inner tube;
an end tube connected to a first end of the threaded tube and pivotably connected to the handle, the threaded rod extending through the connector and inserted into and pivotably connected to the end tube;
a case including a tubular portion and a board which is connected to the tubular portion, a distal end of the tubular portion mounted to a second end of the threaded rod and located within the space;
a resilient member located in the space and biased between the connector and the distal end of the tubular portion, and
a massage disk connected to the case and an eccentric member located in the massage disk, the eccentric member having a base part and an eccentric rod, the second end of the threaded rod extending through the board and connected to the base part, the eccentric rod being eccentric to the threaded rod so as to be pivotably connected to an axis of the massage disk, the threaded rod driving the massage disk to spin by the movement of the eccentric member.

2. The device as claimed in claim 1 further comprising a resilient band hooked between a first hook on the handle and a second hook on the end tube, the resilient band provides a force to return the handle.

3. The device as claimed in claim 1, wherein the eccentric member includes a ring, the base part is a circular part and the ring is mounted to an outside of the base part, the ring has multiple rollers connected to an underside thereof, the massage disk has a recess defined in an underside thereof and the eccentric member is engaged with the recess.

4. The device as claimed in claim 1, wherein the handle has a first sleeve connected between the grips and the threaded tube connected to the first sleeve so as to connect the threaded tube to the handle.

5. The device as claimed in claim 4, wherein the handle has a balancing member and a second sleeve, the balancing member has two ends connected to the two grips and the second sleeve is connected to a mediate portion of the balancing member, the second sleeve is located in alignment with the first sleeve, the threaded tube extending through the second sleeve.

6. The device as claimed in claim 5, wherein the end tube extends through the second sleeve and inserted between the first sleeve and the second sleeve, the end tube is axially connected to the handle.

7. The device as claimed in claim 1, wherein the threaded rod has a pivot extending from the first end thereof and the pivot is pivotably connected to the end tube, a bearing is located between the pivot and the end tube so that the threaded rod is pivotable relative to the end tube.

8. The device as claimed in claim 1, wherein the threaded rod has a pivot extending from the second end thereof and the pivot extends through the board and is pivotably connected to the eccentric member, a bearing is located between the pivot and the board so that the threaded rod is pivotable relative to the case.

9. An abdominal massage device comprising:
a handle having two grips and a threaded tube connected to the handle, the threaded tube located between the two grips, the handle having a first hook on a top thereof;
the threaded tube including an outer tube and an inner tube, the outer tube connected to the handle and the inner tube located in the outer tube, a connector connected to two respective first ends of the inner and outer tubes so as to define an annular space between the inner and outer tubes, the space being sealed by the connector, a threaded rod inserted into the inner tube and threadedly connected to the inner tube;
an end tube connected to a first end of the threaded tube and pivotably connected to the handle, the threaded rod extending through the connector and inserted into and pivotably connected to the end tube, the end tube having a second hook connected to a top thereof;
a case including a tubular portion and a board which is connected to the tubular portion, a distal end of the tubular portion mounted to a second end of the threaded rod and located within the space;
a resilient member being a resilient band and hooked between the first and second hooks, and
a massage disk connected to the case and an eccentric member located in the massage disk, the second end of the threaded rod extending through the board and connected to the base part, an eccentric rod of the eccentric member being eccentric to the threaded rod so as to be pivotably connected to an axis of the massage disk, the threaded rod driving the massage disk to spin by the movement of the eccentric member.
